(19) United States
(12) Patent Application Publication
(10) Pub. No.: US 2023/0289941 A1
(43) Pub. Date: Sep. 14, 2023

(54) METHOD FOR PREDICTING STRUCTURAL FEATURES FROM CORE IMAGES

(71) Applicant: SHELL OIL COMPANY, Houston, TX (US)

(72) Inventors: David Lawrence KIRSCHNER, Houston, TX (US); John SOLUM, Houston, TX (US)

(21) Appl. No.: 17/999,630

(22) PCT Filed: Jun. 22, 2021
(86) PCT No.: PCT/EP2021/066951

§ 371 Date: Nov. 22, 2022

Related U.S. Application Data
(60) Provisional application No. 63/044,567, filed on Jun. 26, 2020.

(51) Int. Cl. G06T 7/00; G06V 10/764; G06V 10/774; G06V 10/82; G06T 7/11

(52) U.S. Cl. CPC G06T 7/0002; G06T 7/11; G06V 10/764; G06V 10/774; G06V 10/82; G06T 2207/20076; G06T 2207/20081; G06T 2207/20084; G06T 2207/30181

(57) ABSTRACT

A method for predicting an occurrence of a structural feature in a core image using a backpropagation-enabled process trained by inputting a set of training images of a core image, iteratively computing a prediction of the probability of occurrence of the structural feature for the set of training images and adjusting the parameters in the backpropagation-enabled model until the model is trained. The trained backpropagation-enabled model is used to predict the occurrence of the structural features in non-training core images. The set of training images may include non-structural features and/or simulated data, including augmented images and synthetic images.

### FIELD OF THE INVENTION

The present invention relates to a method for predicting the occurrence of structural features in core images.

### BACKGROUND OF THE INVENTION

Core images are important for hydrocarbon exploration and production. Images are obtained from intact rock samples retrieved from drill holes either as long (ca. 30 ft (9 m)) cylindrical cores or short (ca. 3 inches (8 cm)) side-wall cores. The cylindrical core samples are photographed with visible and/or UV light, and also imaged with advance imaging technologies such as computerized axial tomography (CAT) scanning. The cores are then cut longitudinally (slabbed) and re-photographed under visible and/or UV light. The circumferential images can be unfolded resulting in a two-dimensional image such that the horizontal axis is azimuth and vertical axis is depth. All images of the intact cylindrical and slabbed core can then be used in subsequent analyses, as presented below.

A significant component of core interpretation focuses on the identification of structural features in core images. Conventionally, the identification of structural features in core images is performed manually by a geologist; a process that is time-consuming, requires specialized knowledge, and is prone to individual bias and/or human error. As a result, the interpretation of core images is expensive and oftentimes results with inconsistent quality. Further, the identification of structural and stratigraphic features of a core and its images may take an experienced geologist multiple days or weeks to complete, depending on the physical length of the core and its structural complexity.

Techniques have been developed to help analyze core images. US2017/0286802A1 (Mezghani et al.) describes a process for automated descriptions of core images and borehole images. The process involves pre-processing an image of a core sample to fill in missing data and to normalize image pixel attributes. Several statistical attributes are computed from the intensity color values of the image pixels (such as maximum intensity, standard deviation of the intensity or intensity contrasts between neighboring pixels). These statistical attributes capture properties related to the color, texture, orientation, size and distribution of grains. These attributes are then compared to descriptions made by geologists in order to associate certain values or ranges for each of the attributes to specific classes in order to describe a core. Application to non-described cores then implies computing the statistical attributes and using the trained model to produce an output core description.

Similarly, Al Ibrahim (“Multi-scale sequence stratigraphy, cyclostratigraphy, and depositional environment of carbonate mudrocks in the Tuwaiq mountain and Hanifa formations, Saudi Arabia” Diss. Colorado School of Mines, 2014) relates to multi-scale automated electrofacies analysis using self-organizing maps and hierarchical clustering to show correlation with lithological variation observations and sequence stratigraphic interpretation. Al Ibrahim notes that his workflow developed for image logs can be applied to core photos having imaging artifacts due to core sample breakage, missing portions of core and depth markers. Accordingly, just as in Mezghani et al, Al Ibrahim proposes to use a multi-point statistics algorithm that takes into account the general vicinity of the affect area to generate artificial rock images to fill in, by interpolation, the missing portions of the image, thereby remedying the artefacts.

Conventional techniques, such as described by Mezghani et al. are limited by the fact that the attributes computed are very simple and therefore difficult to transfer to a variety of structural features with multiple appearances and non-structural artefacts. It is also limited by the fact that each type of geologic feature to be described requires a specific combination of attributes and is therefore difficult to generalize. Further, this technique does not use a backpropagation-enabled process to adjust the training classifier based on the statistical attributes.

Pires de Lima et al. (“Deep convolutional neural networks as a geological image classification tool” The Sedimentary Record 17:2:4-9; 2019; “Convolutional neural networks as aid in core lithofacies classification” Interpretation SF27-SF40; August 2019; and “Convolutional Neural Networks” American Association of Petroleum Geologists Explorer, October 2018) describe a backpropagation-enabled process using a convolutional neural network (CNN) for image classification, which they applied to the classification of images from microfossils, geological cores, petrographic photomicrographs, and rock and mineral hand sample images. Pires de Lima use a model trained with millions of labelled images and transfer learning to classify geologic images. The classification developed by this method is based on associating an image to a single label of a geological feature, and therefore the predictions obtained by this method can only infer a single label to areas of the core images composed of multiple pixels (typically a few hundred pixels by a few hundred pixels).

There is a need for an improved method for training backpropagation-enabled processes in order to predict more accurately and more efficiently the occurrence of structural features in cores and associated core images. Specifically, there is a need for improving the robustness of a trained backpropagation-enabled process by training with simulated data. There is also a need for improving the robustness of a trained backpropagation-enabled process by training for the presence of non-structural features.

### SUMMARY OF THE INVENTION

According to one aspect of the present invention, there is provided a method for predicting an occurrence of a structural feature in a core image, the method comprising the steps of: (a) providing a trained backpropagation-enabled process, wherein a backpropagation-enabled process is trained by (i) inputting a set of training images derived from simulated data into a backpropagation-enabled process, wherein the simulated data is selected from the group consisting of augmented images, synthetic images, and combinations thereof; (ii) inputting a set of labels of structural features associated with the set of training images into the backpropagation-enabled process; and (iii) iteratively computing a prediction of the probability of occurrence of the structural feature for the set of training images and adjusting the parameters in the backpropagation-enabled process, thereby producing the trained backpropagation-enabled process; and (b) using the trained backpropagation-enabled process to predict the occurrence of the structural feature in other core images.

According to another aspect of the present invention, there is provided a method for predicting an occurrence of a structural feature in an image of a core image, the method comprising the steps of: (a) providing a trained backpropagation-enabled process, wherein a backpropagation-enabled process is trained by (i) inputting a set of training images of a core image into a backpropagation-enabled process; (ii) inputting a set of labels of structural features and non-structural features associated with the set of training images into the backpropagation-enabled process, wherein the non-structural features are selected from the group consisting of processing artefacts, acquisition artefacts, and combinations thereof; and (iii) iteratively computing a prediction of the probability of occurrence of the structural feature for the set of training images and adjusting the parameters in the backpropagation-enabled process, thereby producing the trained backpropagation-enabled process; and (b) using the trained backpropagation-enabled process to predict the occurrence of the structural feature in a non-training image of a core image, wherein a distortion of the occurrence of the structural feature by the occurrence of a non-structural feature in the non-training image is reduced.

### BRIEF DESCRIPTION OF THE DRAWINGS

The method of the present invention will be better understood by referring to the following detailed description of preferred embodiments and the drawings referenced therein, in which:

FIG. 1 illustrates embodiments of the method of the present invention for generating a set of training images and associated labels for training a backpropagation-enabled process;

FIG. 2 illustrates examples of training images generated in FIG. 1 for training a backpropagation-enabled process in accordance with the method of the present invention;

FIG. 3 illustrates one embodiment of a first aspect of the method of the present invention, illustrating the training of a backpropagation-enabled process, where the backpropagation-enabled process is a segmentation process;

FIG. 4 illustrates another embodiment of the first aspect of the method of the present invention illustrating the training of a backpropagation-enabled process, where the backpropagation-enabled process is a classification process;

FIG. 5 illustrates an embodiment of a second aspect of the method of the present invention for using the trained backpropagation-enabled segmentation process of FIG. 3 to predict structural features of a non-training core image; and

FIG. 6 illustrates another embodiment of the second aspect of the method of the present invention for using the trained backpropagation-enabled process of FIG. 4 to predict structural features of a non-training core image.

### DETAILED DESCRIPTION OF THE INVENTION

The present invention provides a method for predicting an occurrence of a structural feature in a core image. In accordance with the present invention, a trained backpropagation-enabled process is provided and is used to predict the occurrence of the structural feature in a non-training core images.

### Types of Backpropagation-Enabled Processes

Examples of backpropagation-enabled processes include, without limitation, artificial intelligence, machine learning, and deep-learning. It will be understood by those skilled in the art that advances in backpropagation-enabled processes continue rapidly. The method of the present invention is expected to be applicable to those advances even if under a different name. Accordingly, the method of the present invention is applicable to future advances in backpropagation-enabled processes, even if not expressly named herein.

A preferred embodiment of a backpropagation-enabled process is a deep learning process, including, but not limited to, a deep convolutional neural network.

In one embodiment of the present invention, the backpropagation-enabled process used for prediction of structural and non-structural features is a segmentation process. In another embodiment of the present invention, the backpropagation-enabled process is a classification process. Conventional segmentation and classification processes are scale-dependent. In accordance with the present invention, training data may be provided in different resolutions, thereby providing multiple scales of training data, depending on the scales of the structural features that are being trained to be predicted.

### Training Images and Associated Labels

The backpropagation-enabled process is trained by inputting a set of training images, along with a set of labels of structural features, and iteratively computing a prediction of the probability of occurrence of the structural feature for the set of training images and adjusting the parameters in the backpropagation-enabled process. This process produces the trained backpropagation-enabled process. Using a trained backpropagation-enabled process is more time-efficient and provides more consistent results than conventional manual processes.

Structural features can include, but are not limited to faults, fractures, deformation bands, veins, stylolites, shear zones, boudinage, folds, foliation, cleavage, and other structural features.

In one embodiment, the set of training images and associated labels further comprises non-structural features including, without limitation, labels, box margins, filler material (e.g., STYROFOAM™), items commonly associated with analyzing and archiving of cores in the lab, and combinations thereof.

One of the limitations of conventional processes to effectively train a backpropagation-enabled process is that there may not be enough variability in a set of real core images to correctly predict or identify all required types of structural features. Further, the structural features may be masked or distorted by the presence of non-structural features in core images.

Accordingly, in one embodiment of the present invention, the training images of a core image are derived from simulated data. The simulated data may be selected from augmented images, synthetic images, and combinations thereof. In a preferred embodiment, the training images are a combination of simulated data and real data. The set of labels describing the structural and non-structural features can be expressed as categorical or a categorical ordinal array.

By “augmented images” we mean that the training images from a real core image are manipulated by randomly modifying the azimuth within chosen limits, randomly flipping the vertical direction within chosen limits, randomly modifying the inclination (dip) of features within chosen limits, randomly modifying image colors within chosen limits, randomly modifying intensity within chosen limits, randomly stretching or squeezing the vertical direction within chosen limits, and combinations thereof. Preferably, variations in parameter values are randomly assigned within realistic limits for the parameter values.

By “synthetic images,” we mean that the training images are derived synthetically by one of these two alternative methods, or combination thereof:
a. Modifying a real image by overlaying synthetically generated structural features, and preferably non-structural features, manipulating a real image to remove the core image artefacts, manipulating a real image to add a display or graphical effect that mimics core image acquisition and/or processing artefacts, and combinations thereof.
b. Completely generating a synthetic image by a pattern-imitation approach. A pattern-imitation approach includes, for example, without limitation, statistical methods combining stochastic random fields exhibiting different continuity ranges and types of continuity and a set of rules.

In a preferred embodiment of the method of the present invention, the backpropagation-enabled process is trained with a set of training images that include non-structural features. This provides a method that is more robust to identify structural features under the distortion or masking by different types of non-structural features or artefacts, which is common in core images. For example, any masking of the occurrence of the structural feature by the occurrence of a non-structural feature in a non-training image is reduced by training the backpropagation-enabled process with images of non-structural features. In this way, a better prediction of structural features is achieved, when applied to non-training images of core images.

### Optional Pre-Processing

When the set of training images includes images of real core images and/or when the simulated data is derived from images of real core images, it may be desirable to pre-process the real images before adding to the training set of images, either as real images themselves or as a basis for simulated data.

For example, core images might be normalized in RGB values, smoothed or coarsened, rotated, stretched, subsetted, amalgamated, or combinations thereof.

As another example, real images may be flattened to remove structural dip. In the case of a core image from a vertical well and/ having structural dips or a deviated well, the image may be flattened to a horizontal orientation.

### Types of Training Images

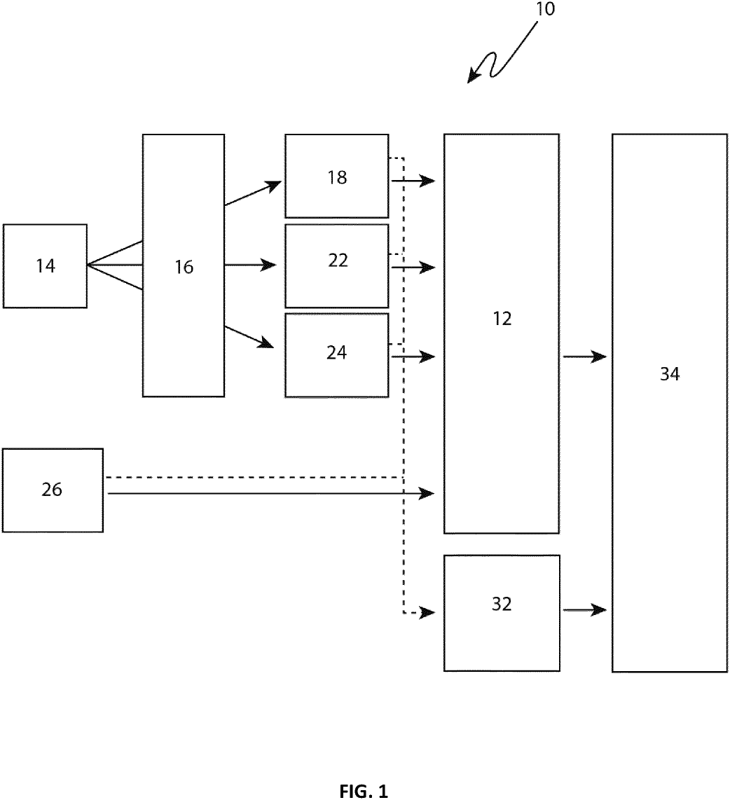

Referring now to FIG. 1, in the method of the present invention 10, a set of training images 12 is generated with images of real core images 14 and/or simulated data. The real core images 14 are optionally subjected to pre-processing 16.

In one embodiment, the real core image data 14, with or without pre-processing 16, is used to produce real training images 18. In another embodiment, the real core image data 14, with or without pre-processing 16, is manipulated to generate augmented training images 22. In a further embodiment, the real core image data 14, with or without pre-processing 16, is modified, as discussed above, to generate synthetic images 24. In yet another embodiment, synthetically generated images 26 are derived by means of numerical pattern-imitation or process-based simulations.

The set of training images 12 is generated from real training images 18, augmented training images 22, synthetic images 24, synthetically generated images 26, and combinations thereof. In a preferred embodiment, the set of training images 12 is generated from augmented training images 22, synthetic images 24, synthetically generated images 26, and combinations thereof. In a more preferred embodiment, the set of training images 12 is generated from images derived from simulated data selected from augmented training images 22, synthetic images 24, synthetically generated images 26, and combinations thereof, together with real training images 18. When a combination of images 18, 22, 24 and/or 26 is used, the training images are merged to provide the set of training images 12.

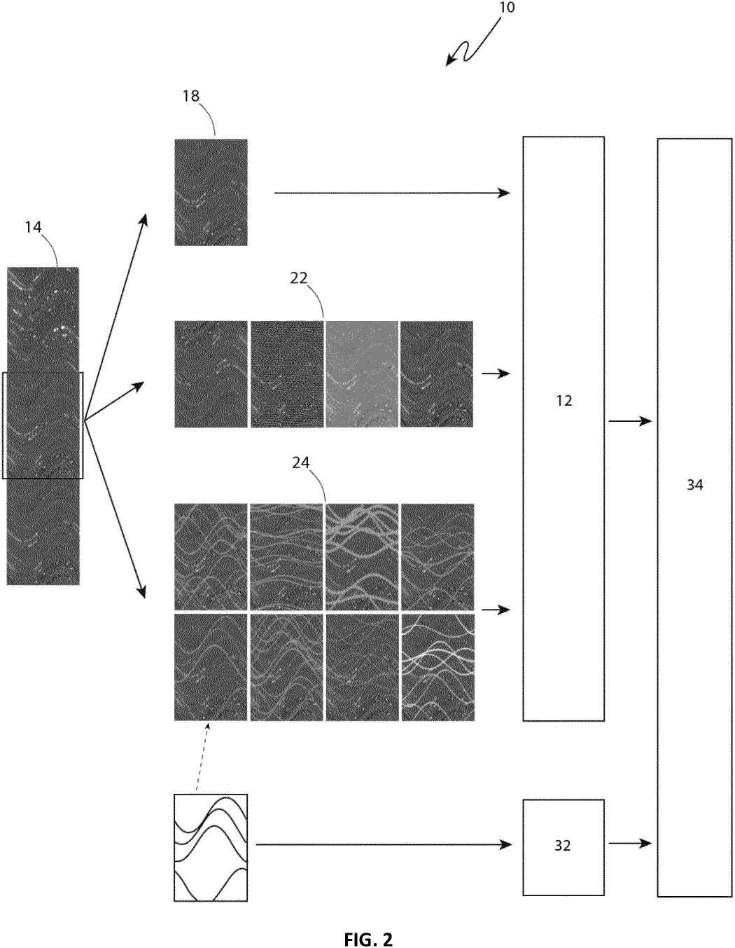

Examples of types of training images showing deformation bands in an eolian deposit for training a backpropagation-enabled process in accordance with the method of the present invention 10 are illustrated in FIG. 2. Real core image data 14, with or without pre-processing (not shown), may be used to produce real training images 18. Alternatively, or in addition, the real core image data 14 is manipulated to generate augmented training images 22. Alternatively, or in addition, the real core image data 14 is modified, as discussed above, to generate synthetic images 24. Alternatively, or in addition, the set of training images 12 is comprised of synthetically generated images 26.

Returning now to FIG. 1, a set of labels 32 associated with the set of training images 12 for structural features, preferably also non-structural features, is also generated, as depicted by the dashed lines in FIG. 1. In the embodiments of real training images 18 and augmented training images 22, the features are labelled manually. In the embodiment of synthetic images 24, manually assigned labels are automatically modified where appropriate. And, in the case of synthetically generated images 26, labels are automatically generated. When a combination of images 18, 22, 24 and/or 26 is used to generate the set of training images 12, the associated labels are merged to provide the set of labels 32.

In conventional processes, certain structural or non-structural features may be less common, creating an imbalance of training data. In a preferred embodiment of the present invention, the set of training data is selected to overcome any imbalances of training data in step 34. For example, where the backpropagation-enabled process is a classification process, the training data set 12 provides similar or same number of images for the classes of structural features, preferably also non-structural features. Where the backpropagation-enabled process is a segmentation process, data imbalances can be overcome by providing a similar or same number of images for each dominant class of structural features, and by further modifying the weights on predictions of classes not sufficiently represented.

### Training Image Resolution and Storage

Training images derived from real core images have a resolution that, by default, is dependent on the imaging tool type and settings used, for example, the number of pixels in a digital camera photograph or resolution of a CAT scan, and other parameters that are known to those skilled in the art. The number of pixels per area of the core image defines the resolution of the training image, wherein the area defined by each pixel represents a maximum resolution of the training image. The resolution of the training image should be selected to provide a pixel size at which the desired structural features are sufficiently resolved and at which a sufficient field of view is provided so as to be representative of the core image sample for a given structural feature to be analyzed. The image resolution is chosen to be detailed enough for feature identification while maintaining enough field of view to avoid distortions of the overall sample. In a preferred embodiment, the image resolution is selected to minimize the computational power to store and conduct further computational activity on the image while providing enough detail to identify a structural feature based on a segmented image.

In an embodiment of the present invention, all of the training images are of the same resolution and are equal to the resolution of other core images to be analyzed with the trained network.

In an embodiment of the present invention, the training images are stored and/or obtained from a cloud-based tool adapted to store images.

### Backpropagation-Enabled Process Training

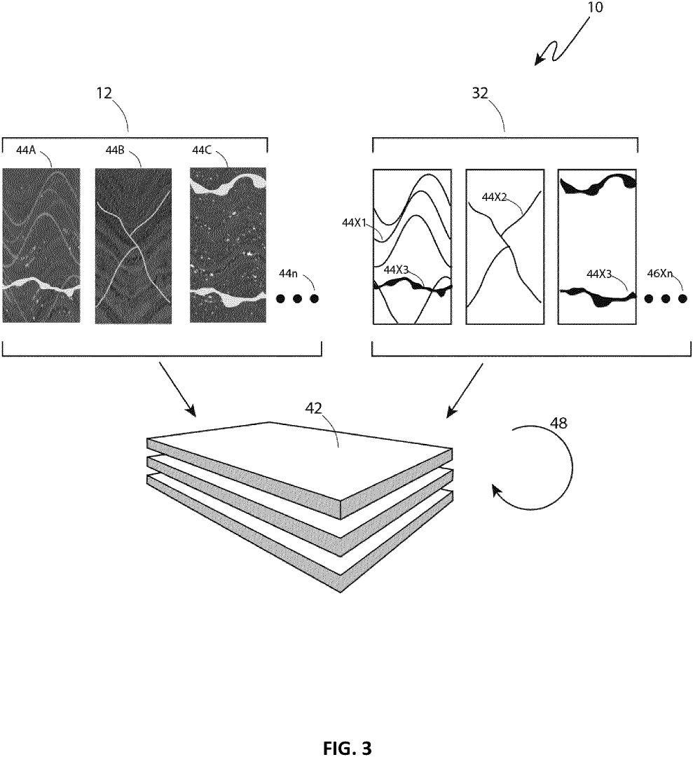

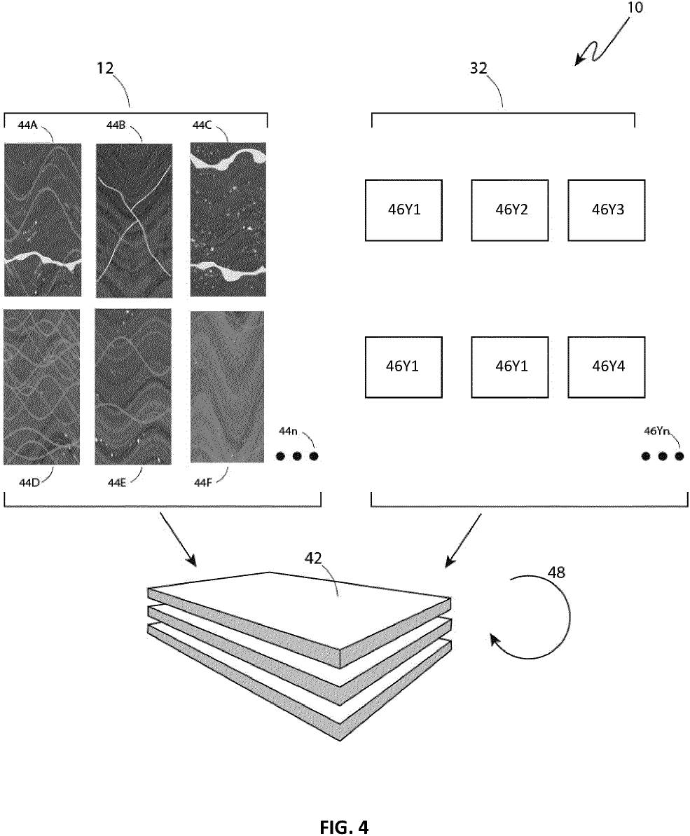

Referring now to the drawings, FIGS. 3 and 4 illustrate two embodiments of the method of the present invention 10 for training a backpropagation-enabled process 42. In the embodiment of FIG. 3, the backpropagation-enabled process is a segmentation process. In the embodiment of FIG. 4, the backpropagation-enabled process is a classification process.

The backpropagation-enabled process 42 is trained by inputting a set 12 of training images 44A – 44n, together with a set 32 of labels 46X1 – 46Xn or 46Y1 – 46Yn.

In the FIG. 3 embodiment, where the backpropagation-enabled process 42 is a segmentation process, the labels 46X1 – 46Xn have the same horizontal and vertical dimensions as the associated training images 44A – 44n. The labels 46X1 – 46Xn describe the presence of a structural feature for each pixel in the associated training image 44A - 44n. In a preferred embodiment, the labels 46X1 – 46Xn also describe the presence of a non-structural feature for each pixel in the associated training image 44A - 44n. In the example shown in FIG. 3, the features are present in multiple training images. For example, label 46X3 identifies the same type of structural feature and therefore is denoted with same label among images in FIG. 3.

In the FIG. 4 embodiment, where the backpropagation-enabled process 42 is a classification process, a single label 46Y1 – 46Yn for each structural feature is associated with each respective training image 44A – 44n. In a preferred embodiment, the labels 46Y1 – 46Yn also include labels for non-structural features associated with the respective training image 44A – 44n. Each structural or non-structural feature may be present in multiple images. For example, the images in 44A, 44D, and 44E have the same type of structural feature 46Y1.

Referring to both FIGS. 3 and 4, the training images 44A – 44n and the associated labels 46X1 - 46Xn and 46Y1 - 46Yn, respectively, are input to the backpropagation-enabled process 42. The process trains a set of parameters in the backpropagation-enabled model 42. The training is an iterative process, as depicted by the arrow 48, in which the prediction of the probability of occurrence of the structural feature is computed, this prediction is compared with the input labels 46X1 – 46Xn or 46Y1 – 46Yn, and then through backpropagation processes the parameters of the model 42 are updated.

The iterative process involves inputting a variety of training images 44A – 44n of the structural features, preferably also non-structural features, together with their associated labels during an iterative process in which the differences in the predictions of the probability of occurrence of each structural feature, preferably also non-structural features, and the labels associated with the training images 44A – 44n are minimized. The parameters in the model 42 are considered trained when a pre-determined threshold in the differences between the probability of occurrence of each structural feature, preferably also non-structural features, and the labels associated with the training images 44A – 44n is achieved, or the backpropagation process has been repeated a predetermined number of iterations.

In accordance with the present invention, the prediction of the probability of occurrence has a prediction dimension of at least one. In the backpropagation-enabled segmentation process embodiment of FIG. 3, the prediction of the occurrence of a structural feature is the same as the image resolution in the set 12 of training images 44A – 44n.

In a preferred embodiment, the training step includes validation and testing. Preferably, results from using the trained backpropagation-enabled process are provided as feedback to the process for further training and/or validation of the process.

### Inferences With Trained Backpropagation-Enabled Process

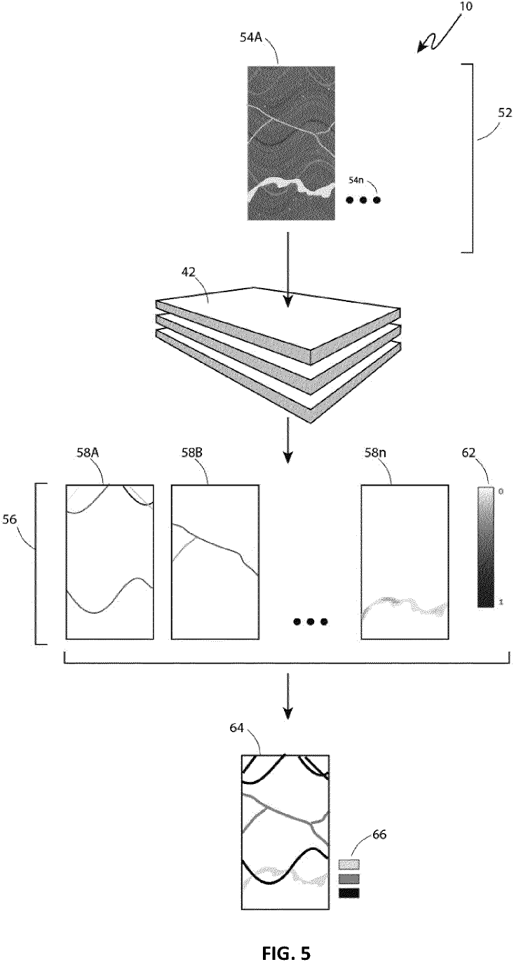

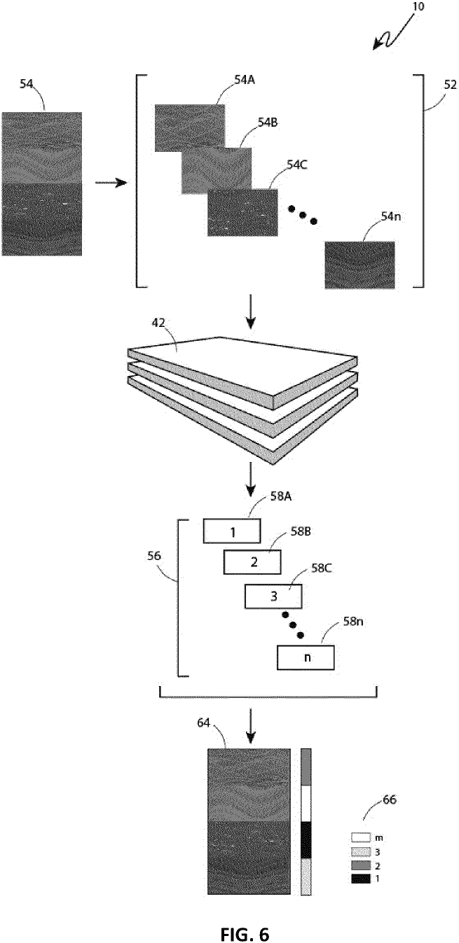

Once trained, the backpropagation-enabled process 42 is used to predict or infer the occurrence of structural features. FIG. 5 illustrates using the trained backpropagation-enabled segmentation process 42 of FIG. 3, while FIG. 6 illustrates using the trained backpropagation-enabled classification process 42 of FIG. 4.

In one embodiment, the probability of occurrence is depicted on a grayscale with 0 (white) to 1 (black). Alternatively, a color scale can be used.

Turning now to FIG. 5, a set 52 of non-training core images 54A – 54n is fed to a trained backpropagation-enabled segmentation process 42. A set 56 of structural feature predictions 58A – 58n are produced showing the presence probability for each feature in 62. For example, in prediction 58A, the probability of the presence of deformation bands is depicted. In prediction 58B, the probability of the presence of small faults is depicted; and, in prediction 58n, the probability of the presence of veins is depicted.

In a preferred embodiment, the set 56 of structural feature predictions 58A – 58n and presence probabilities are combined to produce a combined prediction 64 by selecting the feature with the largest probability for each pixel. Various structural features are illustrated by a color-coded bar 66.

Turning now to FIG. 6, the core image 54 is subdivided into a set of non-training core images 54A – 54n that are fed to a trained backpropagation-enabled classification process 42. A set 56 of structural features predictions 58A – 58n is produced for each of the images with the feature having the highest predicted presence probability.

In a preferred embodiment, the set 56 of structural feature predictions 58A – 58n are combined to produce a combined prediction 64, in which each depth of the core image is associated with a predicted feature. Various structural features are illustrated by a color-coded bar 66. For example, Feature 2 describes a zone rich in deformation bands and Feature “m” an undeformed zone (i.e., without any deformation features).

While preferred embodiments of the present invention have been described, it should be understood that various changes, adaptations and modifications can be made therein within the scope of the invention(s) as claimed below.

What is claimed is:

1. A method for predicting an occurrence of a structural feature in a core image, the method comprising the steps of:
(a) providing a trained backpropagation-enabled process, wherein a backpropagation-enabled process is trained by
i. inputting a set of training images derived from simulated data into a backpropagation-enabled process, wherein the simulated data is selected from the group consisting of augmented images, synthetic images and combinations thereof;
ii. inputting a set of labels of structural features associated with the set of training images into the backpropagation-enabled process; and
iii. iteratively computing a prediction of the probability of occurrence of the structural feature for the set of training images and adjusting the parameters in the backpropagation-enabled process, thereby producing the trained backpropagation-enabled process; and
(b) using the trained backpropagation-enabled process to predict the occurrence of the structural feature in a non-training image of a core image.

2. The method of claim 1, wherein the set of training images further comprises images of a real core image.

3. The method of claim 1, wherein the set of training images further comprises an image of a non-structural feature selected from the group consisting of processing artefacts, acquisition artefacts, and combinations thereof.

4. The method of claim 1, wherein the structural feature is selected from the group consisting of faults, fractures, deformation bands, foliations, cleavages, stylolites, folds, veins, other such structural features, and combinations thereof.

5. The method of claim 1, wherein the backpropagation-enabled process is a segmentation or a classification process.

6. The method of claim 1, wherein the core images are pre-processed.

7. The method of claim 1, wherein step (b) comprises the steps of:
i. inputting a set of non-training core images into the trained backpropagation-enabled process;
ii. predicting a set of probabilities of occurrence of the structural feature; and
iii. producing a prediction of occurrence of the structural feature based on the set of probabilities of occurrence.

8. The method of claim 1, wherein a result of step (b) is used to produce a set of predicted labels to further train the backpropagation-enabled process.

9. A method for predicting an occurrence of a structural feature in an image of a core image, the method comprising the steps of:
(a) providing a trained backpropagation-enabled process, wherein a backpropagation-enabled process is trained by
i. inputting a set of training images of a core image into a backpropagation-enabled process;
ii. inputting a set of labels of structural features and non-structural features associated with the set of training images into the backpropagation-enabled process, wherein the non-structural features are selected from the group consisting of processing artefacts, acquisition artefacts, and combinations thereof; and
iii. iteratively computing a prediction of the probability of occurrence of the structural feature for the set of training images and adjusting the parameters in the backpropagation-enabled process, thereby producing the trained backpropagation-enabled process; and
(b) using the trained backpropagation-enabled process to predict the occurrence of the structural feature in a non-training image of a core image, wherein a distortion of the occurrence of the structural feature by the occurrence of a non-structural feature in the non-training image is reduced.

10. The method of claim 9, wherein the set of training images comprises simulated data selected from the group consisting of augmented images, synthetically generated images, and combinations thereof.

11. The method of claim 10, wherein the set of training images further comprises real images of a core image.

12. The method of claim 9, wherein the structural feature is selected from the group consisting of faults, fractures, deformation bands, foliations, cleavages, stylolites, folds, veins, other such structural features, and combinations thereof.

13. The method of claim 9, wherein the backpropagation-enabled process a segmentation process or a classification process.

14. The method of claim 9, wherein the core images are pre-processed.

15. The method of claim 9, wherein step (b) comprises the steps of:
iv. inputting a set of non-training core images into the trained backpropagation-enabled process;
v. predicting a set of probabilities of occurrence of the structural or non-structural feature; and
vi. producing a combined prediction based on the set of probabilities of occurrence.

16. The method of claim 9, wherein a result of step (b) is used to produce a set of predicted labels to further train the backpropagation-enabled process.
